(19) United States
(12) Patent Application Publication
(10) Pub. No.: US 2022/0295695 A1
(43) Pub. Date: Sep. 22, 2022

(54) TRAVEL ROUTE CONTROL SYSTEM FOR AUTONOMOUS ROBOT

(71) Applicant: Honda Motor Co., Ltd., Tokyo (JP)

(72) Inventors: Akifumi YAMASHITA, Saitama (JP); Satoshi HATORI, Saitama (JP); Ryota HISADA, Tokyo (JP)

(73) Assignee: Honda Motor Co., Ltd., Tokyo (JP)

(21) Appl. No.: 17/206,096

(22) Filed: Mar. 18, 2021

(51) Int. Cl. A01D 34/00; G05D 1/02

(52) U.S. Cl. CPC A01D 34/008; G05D 1/0219; G05D 1/0217; G05D 1/0274; A01D 2101/00

(57) ABSTRACT

A travel route control system for an autonomous robot is provided. The travel route control system includes the autonomous robot and a processor. The processor is configured to function as an obtaining unit and a travel route calculation unit. The obtaining unit obtains work progress information corresponding to a plurality of areas. The travel route calculation unit calculates a travel route of the autonomous robot according to the work progress information obtained by the obtaining unit.

### BACKGROUND

### Technical Field

The disclosure relates to a travel route control system, and more specifically relates to the travel route control system of an autonomous robot.

### Description of Related Art

When the autonomous robot is travelling from a location A to a location B, the autonomous robot may encounter weeds or branches along a travel path. These weeds or branches may act as obstacles blocking the travel path of the autonomous robot and prevent the autonomous robot from reaching its destination.

Therefore, a solution is needed which provides the travel path with fewer obstacles, such that the autonomous robot may have higher success of reaching the destination.

### SUMMARY

According to an embodiment of the disclosure, a travel route control system for an autonomous robot is provided. The travel route control system includes the autonomous robot and a processor. The processor is configured to function as an obtaining unit and a travel route calculation unit. The obtaining unit obtains work progress information corresponding to a plurality of areas. The travel route calculation unit calculates a travel route of the autonomous robot according to the work progress information obtained by the obtaining unit.

According to an embodiment of the disclosure, the work progress information includes progress information about grass cutting of each area of the plurality of areas.

According to an embodiment of the disclosure, the work progress information includes at least one of a work end time of grass cutting, or a scheduled work end time of grass cutting.

According to an embodiment of the disclosure, the travel route calculation unit is configured to determine whether each area of the plurality of areas is travelable according to at least one of the work end time of grass cutting of each area, or the scheduled work end time of grass cutting of each area.

According to an embodiment of the disclosure, the travel route calculation unit is configured to determine an area of the plurality of areas is travelable due to an elapsed time from the work end time of grass cutting of the area is less than or equal to a predetermined threshold time.

According to an embodiment of the disclosure, the travel route calculation unit is configured to determine an area of the plurality of areas is travelable due to a passerby has passed through the area after the work end time of grass cutting.

According to an embodiment of the disclosure, the work progress information further includes progress information about construction of each area.

According to an embodiment of the disclosure, the work progress information is reflected in a map as map information, and the travel route calculation unit calculates the travel route according to the map information.

According to an embodiment of the disclosure, the travel route calculation unit calculates a first travel route of the autonomous robot, the first travel route includes an area where grass cutting is incomplete at the time of calculating the first travel route, and the travel route calculation unit does not re-calculate the first travel route to circumvent the area where grass cutting is incomplete, due to the travel route calculation unit determining that the scheduled work end time of grass cutting of the area where grass cutting is incomplete is earlier than the time that the autonomous robot is scheduled to pass through the area where work is incomplete.

According to an embodiment of the disclosure, the processor outputs an instruction to prioritize the grass cutting of the area where grass cutting is incomplete that is included in the first travel route.

According to an embodiment of the disclosure, the travel route calculation unit is configured to determine an area of the plurality of areas is travelable due to a terminal device has passed through the area after the work end time of grass cutting.

According to an embodiment of the disclosure, the travel route calculation unit is configured to determine an area of the plurality of areas is travelable by estimating a length of a grass of the area is less than 12 cm based on the elapsed time from the work end time of grass cutting of the area.

According to an embodiment of the disclosure, the travel route calculation unit is configured to determine an area of the plurality of areas is travelable by estimating a length of a grass of the area is less than 10 cm based on the elapsed time from the work end time of grass cutting of the area.

According to an embodiment of the disclosure, the travel route calculation unit is configured to determine an area of the plurality of areas is travelable by estimating a length of a grass of the area is less than 8 cm based on the elapsed time from the work end time of grass cutting of the area.

According to an embodiment of the disclosure, a server adapted for calculating a travel route is provided. The server includes a processor configured to function as an obtaining unit and a travel route calculation unit. The obtaining unit obtains work progress information corresponding to a plurality of areas. The travel route calculation unit calculates a travel route of the autonomous robot according to the work progress information obtained by the obtaining unit. The travel route calculated by the travel route calculation unit is transmitted to the autonomous robot.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures.

FIG. 1 is a schematic diagram illustrating a travel route control system of an autonomous robot according to an embodiment of the disclosure.

FIG. 2 is a schematic diagram illustrating an autonomous robot according to an embodiment of the disclosure.

FIG. 3A is a schematic diagram illustrating a map including a plurality of geographical areas according to an embodiment of the disclosure.

FIG. 3B is a schematic diagram illustrating a map including a plurality of geographical areas according to another embodiment of the disclosure.

FIG. 4 is a schematic diagram illustrating grass cutting data included in a work progress information according to an embodiment of the disclosure.

FIG. 5 is a schematic diagram illustrating a map including a plurality of geographical areas and a first travel route and a second travel route according to an embodiment of the disclosure.

FIG. 6A is a picture illustrating a terminal device according to an embodiment of the disclosure.

FIG. 6B is a picture illustrating a terminal device according to an embodiment of the disclosure.

FIG. 7 is a schematic diagram illustrating a travel route control system of an autonomous robot according to another embodiment of the disclosure.

FIG. 8 is a schematic diagram illustrating a first scenario of utilizing the areas determined to be travelable.

FIG. 9 is a schematic diagram illustrating a second scenario of utilizing the areas determined to be travelable.

### DESCRIPTION OF THE EMBODIMENTS

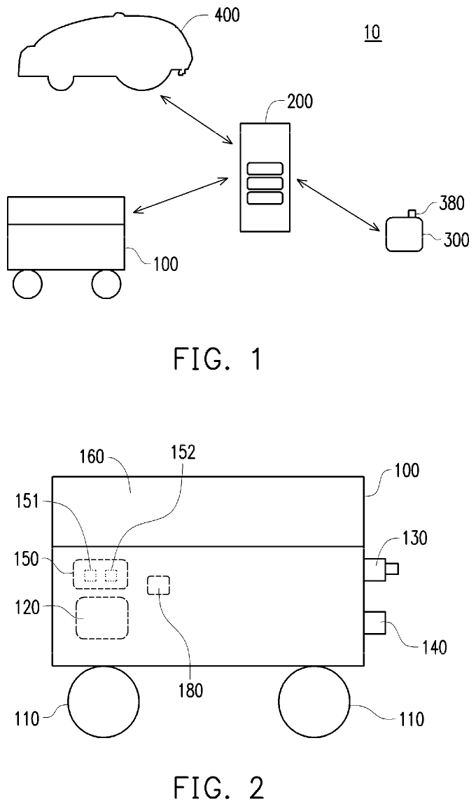

According to an exemplary embodiment of the disclosure, a travel route control system of an autonomous robot is provided. FIG. 1 is a schematic diagram illustrating a travel route control system of an autonomous robot according to an embodiment of the disclosure.

Referring to FIG. 1, the travel route control system 10 includes an autonomous robot 100, a server 200, a terminal device 300 and a lawn mower 400. The autonomous robot 100 is, for example, a transport vehicle adapted to travel from a location A to a location B. For example, the autonomous robot 100 may be a transport vehicle carrying packages for delivery to a residence, business or the like. As another example, the autonomous robot 100 may be carrying equipment at a golfing range or golf course from a location A to a location B. The above are described as examples only, and the autonomous robot 100 is not limited thereto.

FIG. 2 is a schematic diagram illustrating an autonomous robot according to an embodiment of the disclosure. Referring to FIG. 2, the autonomous robot 100 includes a plurality of wheels 110, a motor 120, a camera 130, a laser sensor 140, a processor 150, a goods transporting platform 160, and a global positioning system (GPS) 180. In addition to the camera 130, the laser sensor 140 and the GPS system 180, the autonomous robot 100 may also include Laser Imaging Detection and Ranging (LIDAR), Simultaneous Localization and Mapping (SLAM), Odometry, and other internal sensors and external sensors as a means for self-position recognition. The motor 120 may be an electric motor, and is coupled to at least one of the plurality of wheels 110 to drive a movement of the autonomous robot 100. The motor 120 may be coupled to the plurality of wheels 110 through gears, belts and the like to drive the wheels 110. Further, the autonomous robot 100 includes an automatic driving and steering system (not shown) for navigating a travel route. The autonomous robot 100 may further include a braking system (not shown) in case the autonomous robot 100 needs to come to a stop or slow down. The autonomous robot 100 is configured to travel along a predetermined travel route based on a map information M and a work progress information W (which will be described later).

In the present embodiment, the work progress information W includes data about grass cutting, such as a work end time of grass cutting. As the autonomous robot 100 travels along the predetermined travel route calculated based on the map information M and the work progress information W, the camera 130 and the laser sensor 140 of the autonomous robot 100 detect obstacles in the travel path of the autonomous robot 100. The camera 130 and the laser sensor 140 may be configured to detect obstacles such as, for example, a car, a weed, a tree, a pedestrian or the like. When an obstacle is detected which prevents the autonomous robot 100 from advancing or reaching its destination, the autonomous robot 100 may re-calculate a travel path of the autonomous robot 100 to avoid the obstacle in its travel route.

In the present embodiment, the processor 150 of the autonomous robot 100 is configured to function as an obtaining unit 151 and a travel route calculation unit 152. The obtaining unit 151 obtains work progress information W corresponding to a plurality of geographical areas (A1, A2, A3 . . . An). As an example, the obtaining unit 151 obtains the work progress information W stored in the server 200. The server 200 stores work progress information W. The work progress information W includes data about grass cutting.

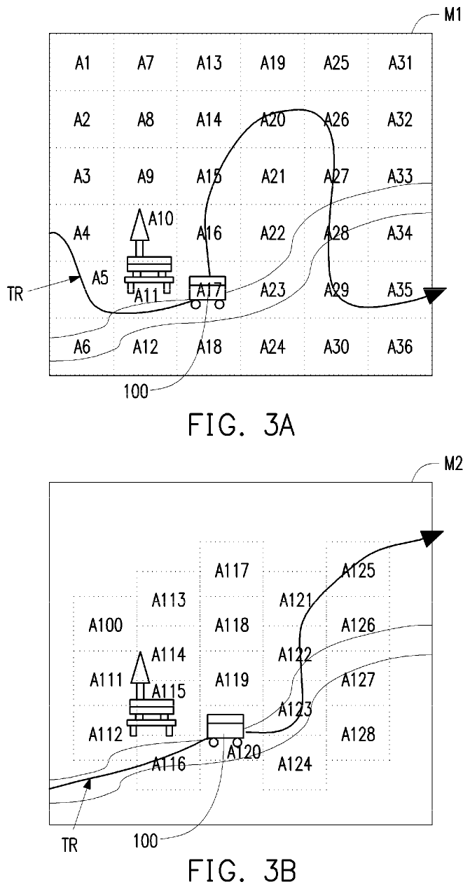

FIG. 3A is a schematic diagram illustrating a map including a plurality of geographical areas according to an embodiment of the disclosure. Referring to FIG. 3A, the map M1 includes a plurality of geographical areas (A1, A2, A3 . . . An) and a travel route TR of the autonomous robot 100 that is calculated by the travel route calculation unit 152. Here, the work progress information W includes progress information about grass cutting of each area of the plurality of areas (A1, A2, A3 . . . An). By understanding the grass cutting progress of each geographical area, the travel route calculation unit 152 may calculate a travel route TR of the autonomous robot 100 according to the work progress information W obtained by the obtaining unit 151. In this way, the travel route calculation unit 152 of the autonomous robot 100 may calculate the travel route T having less weeds or branches, such that the autonomous robot 100 may have a higher success of reaching the destination when traveling along the travel route TR. In addition, the travel route calculation unit 152 may incorporate areas where the work (grass cutting) has been completed into the travel route TR of the autonomous robot 100, such that the autonomous robot 100 may travel to the destination on a stable and fast travel route.

FIG. 3B is a schematic diagram illustrating a map including a plurality of geographical areas according to another embodiment of the disclosure. Referring to FIG. 3B, the map M includes a plurality of geographical areas (A100, A111, A112 . . . Annn) and a travel route TR of the autonomous robot 100 that is calculated by the travel route calculation unit 152. Here, the work progress information W includes progress information about grass cutting of each area of the plurality of areas (A100, A112, A113 . . . Ann).

The difference between FIG. 3A and FIG. 3B is in a layout of the plurality of geographical areas. For example, the plurality of geographical areas (A1, A2, A3 . . . An) in FIG. 3A are aligned in a grid pattern. In comparison, the plurality of geographical areas (A100, A112, A113 . . . Annn) in FIG. 3B are aligned in a staggered-like pattern. It may be understood, the layout of the plurality of geographical areas in the map (M1, M2) may be set according to requirements and is not intended to limit the disclosure. Furthermore, a total number of the plurality of geographical areas (An, Ann) is not intended to limit the disclosure and may be set according to requirements. Furthermore, there is no requirement that a geographical areas must border another geographical area. In the present embodiment shown in FIGS. 3A and 3Bt, the areas are shown as a rectangles, however the area of the present Application is not limited to a rectangle and the area may be other shapes and set according to requirements. In addition, an actual size of the area (square feet, square meter, acre, etc) is not intended to limit the disclosure.

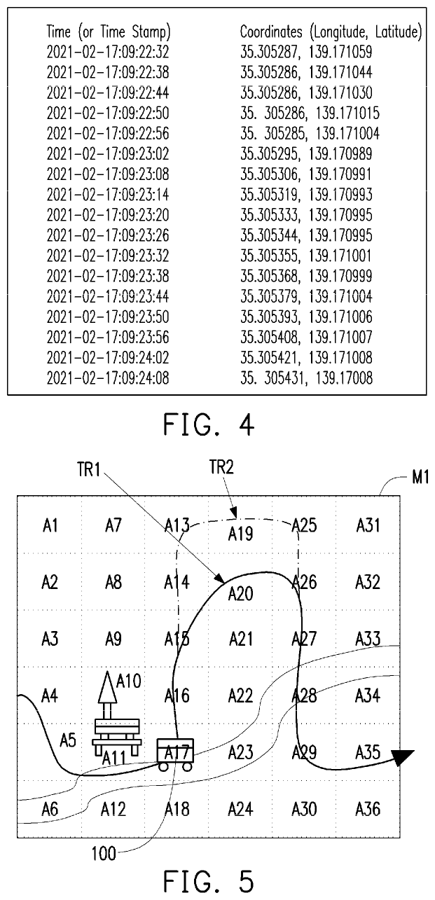

FIG. 4 is a schematic diagram illustrating grass cutting data included in a work progress information according to an embodiment of the disclosure. Referring to FIG. 4, the work progress information W includes data about grass cutting. The work progress information W may include data regarding a work end time of grass cutting, a scheduled work end time of grass cutting, or both the work end time of grass cutting and the scheduled work end time of grass cutting.

In the present embodiment, an example when the work progress information W which includes data about grass cutting will be described. After the obtaining unit 151 obtains the work progress information from the server 200, the travel route calculation unit 152 is configured to determine whether each area of the plurality of areas (A1, A2, A3 . . . An) is travelable according to a work end time of grass cutting of each area. That is to say, the processor 150 determines whether the area, for example the area A15 in FIG. 3A, is travelable or not based on how much time has passed since the last time the grass has been cut at the area A15 according to the work end time of grass cutting obtained from the work progress information W. In more detail, the travel route calculation unit 152 is configured to determine that the area A15 of the plurality of areas (A1, A2, A3 . . . A15 . . . An) is travelable due to an elapsed time from the work end time of grass cutting of the area A15 is less than or equal to a predetermined threshold time. When the processor 150 determines the area A15 is travelable, the area A15 may then be incorporated in to the travel path of the autonomous robot 100 when necessary. On the other hand, when the processor 150 determines an area, for example the area A21 in FIG. 3A, is not travelable, the area A21 will not be incorporated in to the travel path of the autonomous robot 100. That is to say, the travel route calculation unit 152 is configured to determine that the area A21 of the plurality of areas (A1, A2, A3 . . . A21 . . . An) is not travelable due to an elapsed time from the work end time of grass cutting of the area A21 is greater than the predetermined threshold time. Accordingly, the autonomous robot 100 may travel safely through the areas where the processor 150 has determined to be travelable, for example the areas (A4, A5, A11, A17, A16, A15, A14, A20, A26, A27, A28, A29, A35) shown in the travel route TR of FIG. 3A. It should be noted that the travel route TR does not need to pass through every area that is determined to be travelable. In an embodiment of the disclosure, the travel route TR calculated may be the fastest travel route TR based on the work progress information W.

Additionally, when the grass of an area has not been cut, there may be no work end time of grass cutting of the area included in the work progress information W. In other words, the elapsed time from the work end time of grass cutting of the area cannot be determined. In this case, the area may be determined as not travelable by the autonomous robot 100, or the area may be determined as travelable by the autonomous robot 100, and may be determined based on requirements. Accordingly, the autonomous robot 100 may distinguish between the areas where work is completed and the areas where work is incomplete.

The “predetermined threshold time” may be set according to the needs of a user, and is not intended to limit the present disclosure. For example, when the predetermined threshold time is set to 14 days (or 336 hours), the travel route calculation unit 152 determines that the area is travelable within 14 days of the work end time of grass cutting of the area. On the other hand, when more than 14 days since the work end time of grass cutting of the area has elapsed, then the travel route calculation unit 152 determines that the area is not travelable due to the grass has grown too much and may present obstacles to the autonomous robot 100. After a period of time has passed since the work end time of grass cutting, the grass and weeds may grow again and the area may become unstable for traveling. For example, when the grass has grown more than the predetermined threshold time of 14 days, the camera 130 and/or the laser sensor 140 may have a higher rate of detecting obstacles which may prevent the autonomous robot 100 from reaching its destination, therefore the travel route calculation unit 152 may determine that the area is not travelable. The predetermined threshold time may be in days, hours, minutes or the like and is not intended to limit the disclosure.

In one embodiment of the disclosure, the predetermined threshold time is a predetermined time set by the user. In another embodiment of the disclosure, the predetermined threshold time may be set based on an estimation of a current grass length of the area. For example, the processor 150 may calculate how much time has elapsed since the last work end time of grass cutting of the area. Then an equation may be used for calculating the current grass length by multiplying a rate of growth of the grass and the time elapsed. The equation for estimating the grass length may vary according to the season and/or a frequency of rain fall for the area. As one example, the area is determined to be travelable with the elapsed time of 30 days when the processor 150 estimates the grass length of the area is less than 12 cm. In another example, the area is determined to be travelable with the elapsed time of 20 days, when the processor 150 estimates the grass length of the area is less than 10 cm. In another example, the area is determined to be travelable with the elapsed time of 10 days, when the processor 150 estimates the grass length of the area is less than 8 cm.

In the above, an embodiment where the work progress information W includes data about the work end time of grass cutting has been described. Next, an embodiment where the work progress information W includes data about the scheduled work end time of grass cutting will be described.

Referring to FIG. 4 again, the work progress information W which includes data about grass cutting, includes data regarding a scheduled work end time of grass cutting. In other words, the work progress information W includes scheduled grass cutting times that are after (later than) the time instance when the travel route calculation unit 152 is calculating the travel route of the autonomous robot 100 according to the work progress information W obtained by the obtaining unit 151. When the work progress information W includes scheduled work end times of grass cutting, the travel route calculation unit 152 may be configured to determine whether each area of the plurality of areas (A1, A2, A3 . . . An) is travelable according to the scheduled work end time of grass cutting of each area. It should be noted, the scheduled work end time of grass cutting refers to the grass cutting has not been completed yet, but is scheduled to be completed at the time designated by the scheduled work end time of grass cutting. An example will be described below.

FIG. 5 is a schematic diagram illustrating a map including a plurality of geographical areas and a first travel route and a second travel route according to an embodiment of the disclosure. Referring to FIG. 5, the travel route calculation unit 152 calculates a first travel route TR1 of the autonomous robot 100. Here, the first travel route TR1 calculated by the travel route calculation unit 152 may include an area where grass cutting is incomplete at the time of calculating the first travel route TR1, for example the area A20 in FIG. 5. However, the travel route calculation unit 152 does not re-calculate the first travel route TR1 to circumvent the area A20 where grass cutting is incomplete. The travel route calculation unit 152 determines that the scheduled work end time of grass cutting of the area A20 where grass cutting is incomplete will be earlier than the time that the autonomous robot 100 is scheduled to pass through the area A20 where the work is incomplete at the time of calculating the first travel route TR1. In other words, even when the grass cutting of the area A20 is not complete at the time the travel route calculation unit 152 calculates the first travel route TR1, the travel route calculation unit 152 may still maintain the first travel route TR1 without recalculating a second travel route TR2 as long as the grass cutting of the area is scheduled to be completed by the time the autonomous robot 100 is scheduled to pass through the area A20. That is to say, the travel route calculation unit 152 may determine the area A20 as travelable as long as the grass cutting is scheduled to be completed by the time the autonomous robot 100 is scheduled to pass through the area A20.

On the other hand, when the grass cutting of the area A20 is not completed or not scheduled to be completed by the time the autonomous robot 100 is scheduled to pass through the area according to the first travel route TR1, then the travel route calculation unit 152 may re-calculate the second travel route TR2 which circumvents the area A20 where grass cutting is incomplete, and is not scheduled to complete when the autonomous robot 100 is scheduled to pass through the area A20 based on the first travel route TR1. That is to say, the travel route calculation unit 152 re-calculates the second travel route TR2 to pass through the areas A14, A13, A19, A25 to circumvent the area A20.

In this way, a travel path which includes areas where grass cutting is incomplete at the time of calculating the travel route may still be incorporated into the travel path as long as the grass cutting of the area is scheduled to be completed by the time the autonomous robot 100 passes through the area.

Here, the processor 150 may output an instruction to prioritize the grass cutting of the area or areas where grass cutting is incomplete that are included in the first travel route TR1. More specifically, the processor 150 may transmit a signal to instruct the lawn mower or worker to prioritize the cutting of the grass of the area where the autonomous robot 100 is scheduled to pass through. In this way, the grass cutting of the area where grass cutting is incomplete may be completed with certainty prior to the autonomous robot 100 passing through the area.

Now, the obtaining unit 151 may obtain the “work progress information W” in more than one way. As described above, the work progress information W includes progress information about grass cutting of each area of the plurality of areas (A1, A2, A3 . . . An). For example, a lawn mower 400 in FIG. 1 that is equipped with a GPS may transmit work progress information W that includes position data of the lawn mower to the server 200. As an example, the position data may be transmitted in National Marine Electronics Association (NMEA) format wherein the longitudinal and latitudinal coordinates are represented by degrees and decimal minutes. The work progress information shown in FIG. 4 is for schematic illustrative purposes only, and is not intended to limit the disclosure regarding the format in which the work progress information W may be transmitted to the server 200. Here, the position data of the lawn mower 400 transmitted to the server 200 corresponds to geographical areas which the lawn mower 400 has mowed (and/or is scheduled to mow). In addition to the position data of the lawn mower 400, the work progress information W further includes the work end time of grass cutting (and/or the scheduled work end time of grass cutting). That is to say, the work progress information W includes the position data of the lawn mower 400 and the work end time of grass cutting (and/or the scheduled work end time of grass cutting). In the present embodiment, the obtaining unit 151 obtains the work progress information W from the server 200.

After the work progress information W is obtained by the obtaining unit 151, the GPS position data of the lawn mower(s) included in the work progress information W may be corresponded with an area of the plurality of areas (A1, A2, A3 . . . An). In this way, the processor 150 may determine whether a lawn mower has cut the grass at the area. Furthermore, the processor 150 may determine when the grass was cut at the area based on the work end time of grass cutting. Further, the processor 150 may determine when the grass is scheduled to be cut at the area based on the scheduled work end time of grass cutting.

Referring to FIG. 3A and FIG. 3B, the work progress information W may then be reflected in the map M1 and the map M2 as map information, and the travel route calculation unit 152 calculates the travel route TR according to the map information indicating which areas of the plurality of areas (A1, A2, A3 . . . An) are travelable and not travelable. By updating the work progress information W in the map M1 and the map M2 as map information, the latest status of each area of the plurality of areas (A1, A2, A3 . . . An) may be kept track of and shared with a plurality autonomous robots 100.

It should be noted, the present disclosure does not distinguish between grass cutting and lawn mowing. In the present disclosure, grass cutting and lawn mowing both refer to the grass being cut. Furthermore, the lawn mower 400 described above may be an autonomous lawn mower, a lawn mower operated manually by a worker, or a lawn mower operated remotely by a worker and is not intended to limit the disclosure. When the lawn mower 400 is operated manually by a worker, the GPS data along with the work end time of grass cutting or scheduled work end time of grass cutting may be transmitted to the server 200 by the worker.

In another embodiment of the disclosure, the obtaining unit 151 may obtain the work progress information W through the position data of a terminal device 300 as shown in FIG. 1. For example, a terminal device 300 equipped with a GPS 380 may transmit work progress information W that includes position data of the terminal device 300 and a time stamp to the server 200. As an example, the position data may be transmitted in National Marine Electronics Association (NMEA) Format wherein the longitudinal and latitudinal coordinates are represented by degrees and decimal minutes. The work progress information shown in FIG. 4 is for schematic illustrative purposes only, and is not intended to limit the disclosure regarding the data and format in which the work progress information W may be transmitted to the server 200. Here, the position data of the terminal device 300 transmitted to the server 200 corresponds to geographical areas which the terminal device has passed through. In addition to the position data of the terminal device 300, the work progress information W further includes the time stamp of when the terminal device 300 passed through each area. That is to say, the work progress information W includes the position data of the terminal device 300 and the time stamp of when the terminal device passed through each area indicated by the position data.

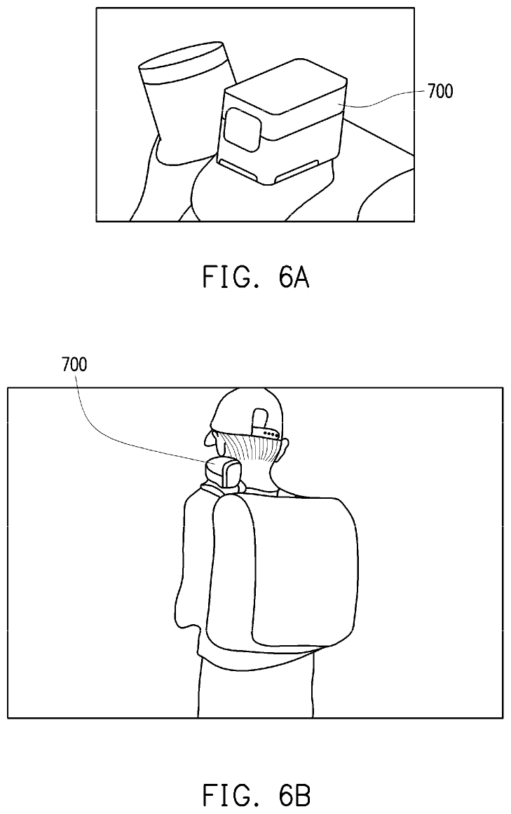

FIG. 6A is a picture illustrating a terminal device according to an embodiment of the disclosure. FIG. 6B is a picture illustrating a terminal device according to an embodiment of the disclosure. Referring to FIG. 6A and FIG. 6B, the terminal device 300 may be, for example, a portable terminal which the user may carry on his or her shoulder. The terminal device 300 includes a GPS. The terminal device 300 may be capable of transmitting GPS data and time stamp.

After the obtaining unit 151 obtains the work progress information W from the server 200, the travel route calculation unit 152 is configured to determine whether each area of the plurality of areas (A1, A2, A3 . . . An) is travelable according to the time stamp of the terminal device 300 passing through the area. That is to say, the processor 150 may determine a state of the weeds or grass growing at each area and a road surface condition of the area based on a passerby (equipped with the terminal device 300) passing through the area and how much time has elapsed since the passerby has passed through the area, in order to determine whether the area is travelable. The travel route calculation unit 152 is configured to determine that an area of the plurality of areas is travelable due to an elapsed time from the time the passerby has passed through the area is less than or equal to a predetermined threshold time. When the processor 150 determines the area is travelable, the area may then be incorporated in to the travel path of the autonomous robot 100 when necessary.

As described above, in the present disclosure, the travel route calculation unit 152 may be configured to determine an area of the plurality of areas (A1, A2, A3 . . . An) is travelable due to a passerby has passed through the area (i.e. a passerby carrying a terminal device 300 has passed through the area).

In another embodiment of the disclosure, in addition to the grass cutting data, the work progress information W may further include progress information about construction of each area. In other words, the travel route calculation unit 152 may be configured to determine whether each area of the plurality of areas is travelable according to a work end time of construction of each area, or a scheduled work end time of construction of each area. In this way, the areas that are not passable due to ongoing construction may be prevented from being incorporated into the travel route TR.

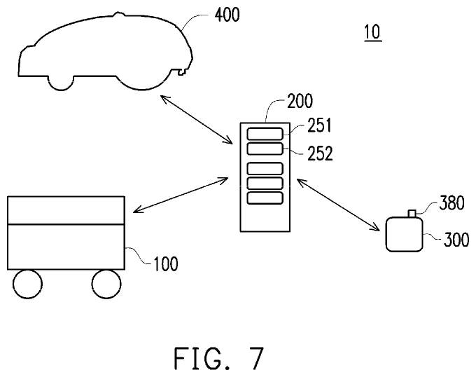

FIG. 7 is a schematic diagram illustrating a travel route control system of an autonomous robot according to another embodiment of the disclosure. Referring to FIG. 7, the main difference between the travel route control system in FIG. 7 and the travel route control system in FIG. 1 is in the obtaining unit and the travel route calculation unit. In the travel route control system of an autonomous robot in FIG. 1, the obtaining unit 151 and the travel route calculation unit 152 are included in the autonomous robot 100. In comparison, in the travel route control system of an autonomous robot in FIG. 7, the obtaining unit 251 and the travel route calculation unit 252 are included in the server 200. As seen in the embodiment of FIG. 7, the server 200 includes a processor 250 configured to function as an obtaining unit 251 and a travel route calculation unit 252. It should be noted, in other embodiments, the processor configured to function as the obtaining unit and the travel route calculation unit may be provided in a cloud network and the like, and is not intended to limit the disclosure. That is to say, a location of the obtaining unit and the travel route calculation unit may be disposed according to requirements and is not intended to limit the disclosure.

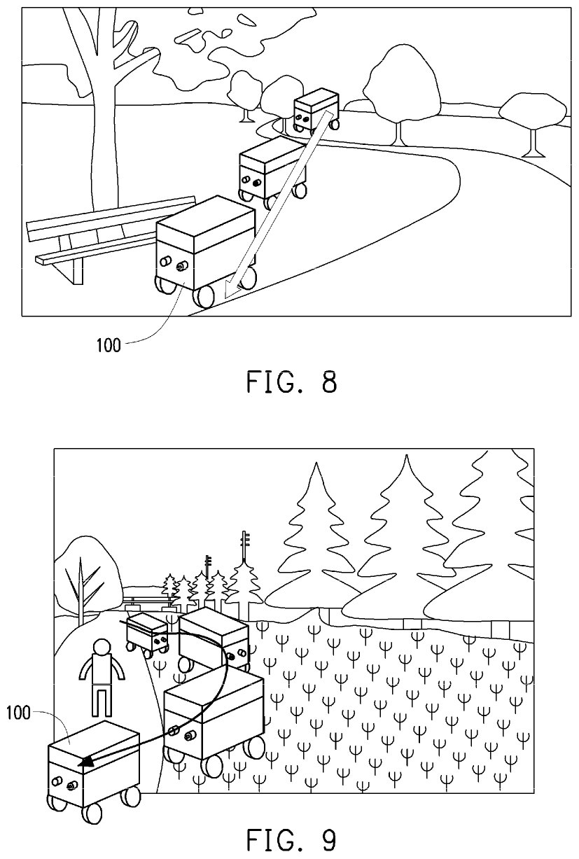

FIG. 8 is a schematic diagram illustrating a first scenario of utilizing the areas determined to be travelable. Referring to FIG. 8, the travel route calculation unit 152, 252 may actively incorporate the areas that are determined to be travelable, namely the areas where grass cutting is completed or is scheduled to be completed, into the travel route TR of the autonomous robot 100, when calculating the travel route TR of the autonomous robot 100. That is to say the travel route calculation unit 152, 252 may be configured to actively calculate a travel route TR that cuts across large parks and/or grassy areas.

FIG. 9 is a schematic diagram illustrating a second scenario of utilizing the areas determined to be travelable. Referring to FIG. 9, the areas which the travel route calculation unit 152, 252 have determined as travelable, namely the areas where grass cutting is completed, may be used as an avoidance place in case of an emergency situation. For example, when obstacles such as a car, a weed, a tree, a pedestrian or the like are detected by the camera 130 and/or the laser sensor 140 to be blocking the travel route TR of the autonomous robot 100 and preventing the autonomous robot 100 from reaching its destination, the travel route calculation unit 152, 252 may re-calculate the second travel path TR2 of the autonomous robot 100 incorporating areas determined to be travelable by the autonomous robot 100 to avoid the obstacle in its travel route.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. A travel route control system for an autonomous robot, comprising:
the autonomous robot;
a processor configured to function as:
an obtaining unit that obtains work progress information corresponding to a plurality of areas;
a travel route calculation unit that calculates a travel route of the autonomous robot according to the work progress information obtained by the obtaining unit.

2. The travel route control system for the autonomous robot according to claim 1, wherein the work progress information includes progress information about grass cutting of each area of the plurality of areas.

3. The travel route control system for the autonomous robot according to claim 2, wherein the work progress information includes at least one of a work end time of grass cutting, or a scheduled work end time of grass cutting.

4. The travel route control system for the autonomous robot according to claim 3, wherein the travel route calculation unit is configured to determine whether each area of the plurality of areas is travelable according to at least one of the work end time of grass cutting of each area, or the scheduled work end time of grass cutting of each area.

5. The travel route control system for the autonomous robot according to claim 4, wherein the travel route calculation unit is configured to determine an area of the plurality of areas is travelable due to an elapsed time from the work end time of grass cutting of the area is less than or equal to a predetermined threshold time.

6. The travel route control system for the autonomous robot according to claim 3, wherein, the travel route calculation unit is configured to determine an area of the plurality of areas is travelable due to a passerby has passed through the area after the work end time of grass cutting.

7. The travel route control system for the autonomous robot according to claim 2, wherein the work progress information further includes progress information about construction of each area.

8. The travel route control system for the autonomous robot according to claim 1, wherein the work progress information is reflected in a map as map information, and the travel route calculation unit calculates the travel route according to the map information.

9. The travel route control system for the autonomous robot according to claim 2, wherein the work progress information is reflected in a map as map information, and the travel route calculation unit calculates the travel route according to the map information.

10. The travel route control system for the autonomous robot according to claim 3, wherein the work progress information is reflected in a map as map information, and the travel route calculation unit calculates the travel route according to the map information.

11. The travel route control system for the autonomous robot according to claim 7, wherein the work progress information is reflected in a map as map information, and the travel route calculation unit calculates the travel route according to the map information.

12. The travel route control system for the autonomous robot according to claim 3, wherein
the travel route calculation unit calculates a first travel route of the autonomous robot,
the first travel route includes an area where grass cutting is incomplete at the time of calculating the first travel route, and
the travel route calculation unit does not re-calculate the first travel route to circumvent the area where grass cutting is incomplete, due to the travel route calculation unit determining that the scheduled work end time of grass cutting of the area where grass cutting is incomplete is earlier than the time that the autonomous robot is scheduled to pass through the area where work is incomplete.

13. The travel route control system for the autonomous robot according to claim 12, wherein the processor outputs an instruction to prioritize the grass cutting of the area where grass cutting is incomplete that is included in the first travel route.

14. The travel route control system for the autonomous robot according to claim 6, wherein, the travel route calculation unit is configured to determine an area of the plurality of areas is travelable due to a terminal device has passed through the area after the work end time of grass cutting.

15. The travel route control system for the autonomous robot according to claim 5, wherein the travel route calculation unit is configured to determine an area of the plurality of areas is travelable by estimating a length of a grass of the area is less than 12 cm based on the elapsed time from the work end time of grass cutting of the area.

16. The travel route control system for the autonomous robot according to claim 15, wherein the travel route calculation unit is configured to determine an area of the plurality of areas is travelable by estimating a length of a grass of the area is less than 10 cm based on the elapsed time from the work end time of grass cutting of the area.

17. The travel route control system for the autonomous robot according to claim 15, wherein the travel route calculation unit is configured to determine an area of the plurality of areas is travelable by estimating a length of a grass of the area is less than 8 cm based on the elapsed time from the work end time of grass cutting of the area.

18. A server adapted for calculating a travel route, the server comprising:
a processor configured to function as:
an obtaining unit that obtains work progress information corresponding to a plurality of areas;
a travel route calculation unit that calculates a travel route of the autonomous robot according to the work progress information obtained by the obtaining unit,
wherein the travel route calculated by the travel route calculation unit is transmitted to the autonomous robot.
